(19) United States
(12) Patent Application Publication
(10) Pub. No.: US 2022/0221705 A1
(43) Pub. Date: Jul. 14, 2022

(54) OPTICAL APPARATUS AND SOLID IMMERSION LENS

(71) Applicant: HAMAMATSU PHOTONICS K.K., Hamamatsu-shi (JP)

(72) Inventor: Soh UENOYAMA, Hamamatsu-shi (JP)

(73) Assignee: HAMAMATSU PHOTONICS K.K., Hamamatsu-shi (JP)

(21) Appl. No.: 17/559,040

(22) Filed: Dec. 22, 2021

(30) Foreign Application Priority Data
Jan. 12, 2021 (JP) 2021-003043

(51) Int. Cl. G02B 21/33; G02B 21/24; G01N 21/3563; G01N 21/95

(52) U.S. Cl. CPC G02B 21/33; G02B 21/248; G01N 2021/8461; G01N 21/9501; G01N 2021/3568; G01N 21/3563

(57) ABSTRACT

An optical apparatus includes a stage configured to support a semiconductor device, a solid immersion lens configured to be brought into contact with the semiconductor device supported by the stage, and a photodetector disposed at a position opposite to the stage with respect to the solid immersion lens on an optical path passing through the solid immersion lens. The solid immersion lens includes a base part having a first surface to be brought into contact with the semiconductor device and a second surface opposite to the first surface, and a meta-lens disposed on the second surface.

### TECHNICAL FIELD

The present disclosure relates to an optical apparatus and a solid immersion lens.

### BACKGROUND

As a method for observing an object, a method in which a solid immersion lens is brought into contact with the object and a magnified image of the object is acquired to observe the object is known. For example, Japanese Unexamined Patent Application, First Publication No. 2019-197097 describes a method in which a meta-solid immersion lens having a plurality of antenna parts disposed at a period smaller than a wavelength of incident light is prepared and the plurality of antenna parts are brought into contact with an object to acquire a magnified image of the object with high spatial resolution.

### SUMMARY

The meta-solid immersion lens described in Patent Document 1 is effective in that a solid immersion lens can be made thinner, but great care must be taken not to damage a plurality of antenna parts when the plurality of antenna parts are brought into contact with an object.

Therefore, it is an objective of the present disclosure to provide an optical apparatus including a solid immersion lens in which thinning and easy handling are realized, and such a solid immersion lens.

An optical apparatus of one aspect of the present disclosure includes a support part configured to support an object, a solid immersion lens configured to be brought into contact with the object supported by the support part, and an optical device disposed at a position opposite to the support part with respect to the solid immersion lens on an optical path passing through the solid immersion lens, wherein the solid immersion lens includes a base part having a first surface to be brought into contact with the object and a second surface opposite to the first surface, and a meta-lens disposed on the second surface.

### BRIEF DESCRIPTION OF THE DRAWINGS

FIG. 1 is a block diagram of an optical apparatus of one embodiment.

FIG. 2 is a cross-sectional view of a solid immersion lens unit illustrated in FIG. 1.

FIG. 3 is a front view of a solid immersion lens illustrated in FIG. 2.

FIG. 4 is a bottom view of the solid immersion lens illustrated in FIG. 2.

FIG. 5 is a plan view of the solid immersion lens illustrated in FIG. 2.

FIG. 6 is a schematic view of a meta-lens illustrated in FIG. 3.

FIG. 7 is a view for explaining that an effective refractive index has a distribution in the meta-lens illustrated in FIG. 3.

FIGS. 8A and 8B are views for explaining a method of forming the meta-lens of the solid immersion lens illustrated in FIG. 2.

FIGS. 9A and 9B are views for explaining a method of forming the meta-lens of the solid immersion lens illustrated in FIG. 2.

FIGS. 10A and 10B are views for explaining a method of forming the meta-lens of the solid immersion lens illustrated in FIG. 2.

FIGS. 11A and 11B are views for explaining a method of forming a first portion of the solid immersion lens illustrated in FIG. 2.

FIGS. 12A and 12B are views for explaining a method of forming a first portion of the solid immersion lens illustrated in FIG. 2.

FIGS. 13A and 13B are views for explaining a method of forming a first portion of the solid immersion lens illustrated in FIG. 2.

### DETAILED DESCRIPTION

Hereinafter, embodiments of the present disclosure will be described in detail with reference to the drawings. Further, in each of the drawings, the same or corresponding portions will be denoted by the same reference signs, and duplicate description thereof will be omitted.

### [Configuration of Optical Apparatus]

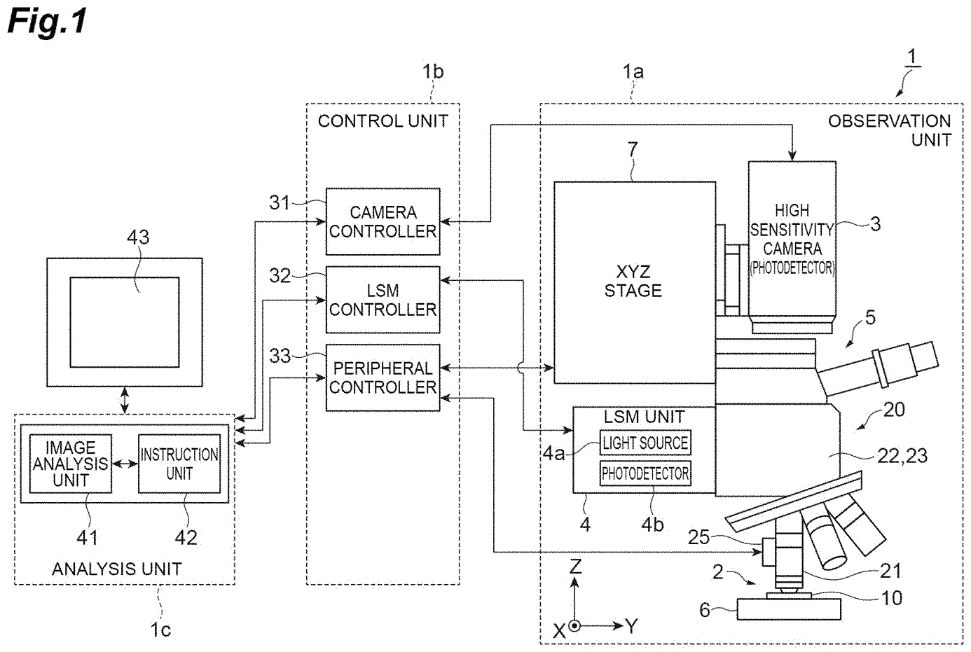

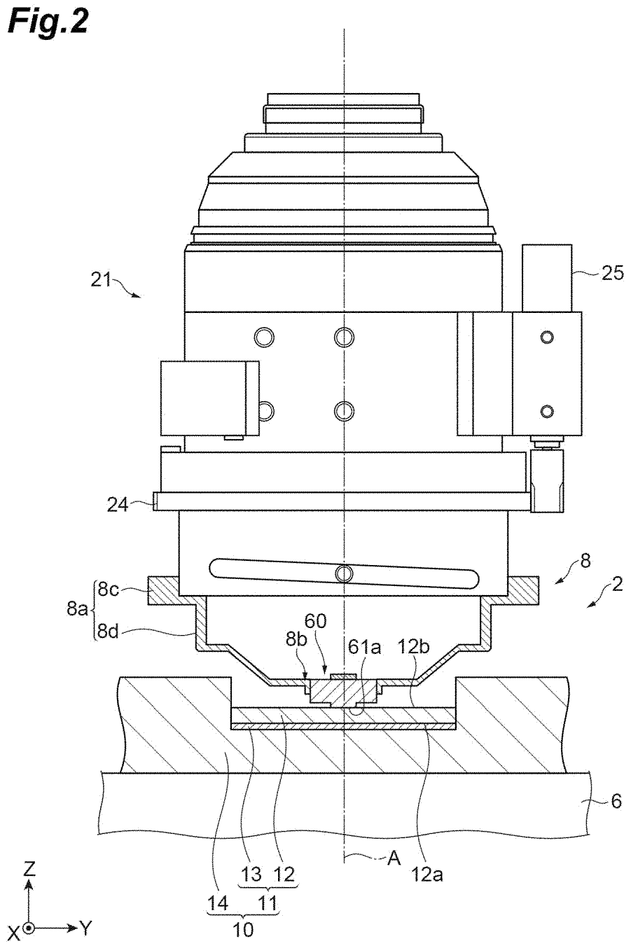

As illustrated in FIGS. 1 and 2, an optical apparatus 1 is an apparatus for observing, for example, a semiconductor device (object) 11 included in a mold-type semiconductor device 10. Specifically, the optical apparatus 1 is a semiconductor failure analysis apparatus for analyzing for failures in the semiconductor device 11 by, for example, acquiring a magnified image of the semiconductor device 11 and inspecting internal information of the semiconductor device 11 on the basis of the magnified image.

The mold-type semiconductor device 10 is one in which the semiconductor device 11 is molded with a resin 14. The internal information of the semiconductor device 11 includes information on, for example, a circuit pattern of the semiconductor device 11, light emission from the semiconductor device 11, and heat generation in the semiconductor device 11. As the light emission, light emission based on a defect of the semiconductor device 11 and transient light emission associated with a switching operation of a transistor in the semiconductor device 11 can be exemplified. As the heat generation, heat generation based on a defect in the semiconductor device 11 can be exemplified.

The semiconductor device 11 includes a semiconductor substrate 12 and an integrated circuit 13. The integrated circuit 13 is formed on a surface 12a of the semiconductor substrate 12. The semiconductor device 11 is embedded in the resin 14 so that a back surface 12b of the semiconductor substrate 12 is exposed. The mold-type semiconductor device 10 is disposed on a stage (support part) 6 so that the back surface 12b of the semiconductor device 11 faces upward. That is, the stage 6 supports the semiconductor device 11. As an example, the semiconductor substrate 12 is a silicon substrate, and in this case, a refractive index of the semiconductor substrate 12 is about 3.5.

The optical apparatus 1 includes an observation unit 1a, a control unit 1b, and an analysis unit 1c. The observation unit 1a observes the semiconductor device 11. The control unit 1b controls an operation of each part of the observation unit 1a. The analysis unit 1c performs processing, instructions, and the like needed for analyzing the semiconductor device 11.

The observation unit 1a includes a solid immersion lens unit 2, a high-sensitivity camera (optical apparatus, photodetector) 3, a laser scanning optical system (LSM) unit 4, an optical system 20, and an XYZ stage 7. The solid immersion lens unit 2 is a lens unit for observing the semiconductor device 11. The high-sensitivity camera 3 and the LSM unit 4 are means for observing the semiconductor device 11. The XYZ stage 7 is a mechanism for moving the high-sensitivity camera 3 and the LSM unit 4 in an X direction, a Y direction, and a Z direction. The X and Y directions are horizontal directions perpendicular to each other, and the Z direction is a vertical direction with respect to an XY plane.

The solid immersion lens unit 2 includes a solid immersion lens 60 and a solid immersion lens holder (holding part) 8. The solid immersion lens 60 is brought into contact with the semiconductor device 11 supported by the stage 6. The solid immersion lens 60 has a first surface 61a to be brought into contact with the semiconductor device 11 (specifically, the back surface 12b of the semiconductor substrate 12). The first surface 61a is a surface (here, a lower surface) on the semiconductor device 11 side among outer surfaces of the solid immersion lens 60.

The solid immersion lens holder 8 holds the solid immersion lens 60 so that the solid immersion lens 60 is positioned below an objective lens 21 of the optical system 20. The solid immersion lens holder 8 is formed of, for example, a metal such as aluminum. The solid immersion lens holder 8 includes a cylindrical main body part 8a and a lens holding part 8b. The main body part 8a is attached to a lower end portion of the objective lens 21. The lens holding part 8b is provided at an end portion of the main body part 8a on the semiconductor device 11 side (a side opposite to the objective lens 21) and holds the solid immersion lens 60.

The main body part 8a passes infrared laser light L output from a light source 4a of the LSM unit 4 to the solid immersion lens 60 side and passes light reflected by the semiconductor device 11 and emitted from the solid immersion lens 60 to the objective lens 21 side. The main body part 8a includes a circumferential wall part 8c and an extension wall part 8d. The circumferential wall part 8c is a cylindrical portion configured to be externally fitted to the lower end portion of the objective lens 21 and screwed to the lower end portion of the objective lens 21. The extension wall part 8d is a portion configured to extend between the circumferential wall part 8c and the lens holding part 8b. A center of the solid immersion lens holder 8 can be positioned on an optical axis A of the objective lens 21 by screwing the circumferential wall part 8c and the lower end portion of the objective lens 21 together. Thereby, a position of the solid immersion lens 60 held by the solid immersion lens holder 8 can be adjusted by driving of the XYZ stage 7.

The lens holding part 8b has a clearance (gap) with respect to the solid immersion lens 60. Thereby, the lens holding part 8b holds the solid immersion lens 60 in a state of being able to swing in a state before the solid immersion lens 60 comes into contact with the semiconductor device 11. When the first surface 61a of the solid immersion lens 60 is brought into contact with the back surface 12b of the semiconductor substrate 12 from this state, the solid immersion lens 60 swings with respect to the lens holding part 8b, and thereby the first surface 61a follows the back surface 12b of the semiconductor substrate 12 to be in close contact therewith. Therefore, for example, even when the back surface 12b of the semiconductor substrate 12 is inclined with respect to the optical axis A, the first surface 61a can follow the back surface 12b of the semiconductor substrate 12 to be satisfactorily in close contact therewith.

The high-sensitivity camera 3 is disposed at a position opposite to the stage 6 with respect to the solid immersion lens 60 on an optical path passing through the solid immersion lens 60. The high-sensitivity camera 3 outputs image data for creating an image such as a circuit pattern of the semiconductor device 11. The high-sensitivity camera 3 includes a CCD area image sensor, a CMOS area image sensor, an InGaAs area image sensor, or the like.

The LSM unit 4 includes the light source (optical device) 4a and a photodetector (optical device) 4b. The light source 4a and the photodetector 4b are disposed at positions opposite to the stage 6 with respect to the solid immersion lens 60 on the optical path passing through the solid immersion lens 60. The light source 4a emits infrared laser light. The light source 4a may be, for example, a semiconductor laser. The photodetector 4b detects reflected light from the semiconductor device 11. The photodetector 4b may be, for example, an avalanche photodiode, a photodiode, or a photomultiplier tube. The LSM unit 4 generates image data for creating an image such as a circuit pattern of the semiconductor device 11 by scanning the semiconductor device 11 with infrared laser light in the X and Y directions.

The optical system 20 includes the objective lens 21, a camera optical system 22, and an LSM unit optical system 23. The objective lens 21 is disposed at a position between the solid immersion lens 60 and the LSM unit 4 on the optical path passing through the solid immersion lens 60. The position at which the objective lens 21 is disposed is also a position between the solid immersion lens 60 and the high-sensitivity camera 3 on the optical path passing through the solid immersion lens 60. A plurality of objective lenses 21 having different magnifications are provided and can be switched between. The objective lens 21 includes a correction ring 24. When the correction ring 24 is adjusted, a focus of the objective lens 21 can be accurately aligned with a predetermined portion of the semiconductor device 11.

The camera optical system 22 guides reflected light from the semiconductor device 11 that has passed through the solid immersion lens 60 and the objective lens 21 to the high-sensitivity camera 3. The LSM unit optical system 23 reflects infrared laser light from the LSM unit 4 to the objective lens 21 side by a beam splitter (not illustrated) and guides it to the semiconductor device 11. The LSM unit optical system 23 guides the reflected light from the semiconductor device 11 that has passed through the solid immersion lens 60 and the objective lens 21 and is directed to the high-sensitivity camera 3 to the LSM unit 4. Further, the optical system 20 further includes a microscope 5 for observing the semiconductor device 11.

As described above, the XYZ stage 7 moves the solid immersion lens unit 2, the high-sensitivity camera 3, the LSM unit 4, the optical system 20, and the like in the X, Y, and Z directions. An operation of the XYZ stage 7 is controlled by the control unit 1b.

The control unit 1b includes a camera controller 31, a laser scan (LSM) controller 32, and a peripheral controller 33. The camera controller 31 controls an operation of the high-sensitivity camera 3. The LSM controller 32 controls an operation of the LSM unit 4. The peripheral controller 33 controls an operation of the XYZ stage 7. That is, movement, position alignment, focusing, and the like of the solid immersion lens unit 2, the high-sensitivity camera 3, the LSM unit 4, the optical system 20, and the like to a position corresponding to an observation position of the semiconductor device 11 are controlled. Further, the peripheral controller 33 drives a correction ring adjusting motor 25 attached to the objective lens 21 to control the correction ring 24. Observation conditions or the like of the semiconductor device 11 performed by the observation unit 1a can be controlled by the control unit 1b.

The analysis unit 1c includes an image analysis unit 41 and an instruction unit 42. The image analysis unit 41 creates an image on the basis of image information (image data) output from the camera controller 31 and the LSM controller 32 and executes necessary analysis processing or the like. The instruction unit 42 refers to an input content from an operator, an analysis content of the image analysis unit 41, and the like and gives a necessary instruction regarding execution of an inspection of the semiconductor device 11 in the observation unit 1a via the control unit 1b. Images, data, and the like acquired or analyzed by the analysis unit 1c can be displayed on a display device 43 connected to the analysis unit 1c.

### [Configuration of Solid Immersion Lens]

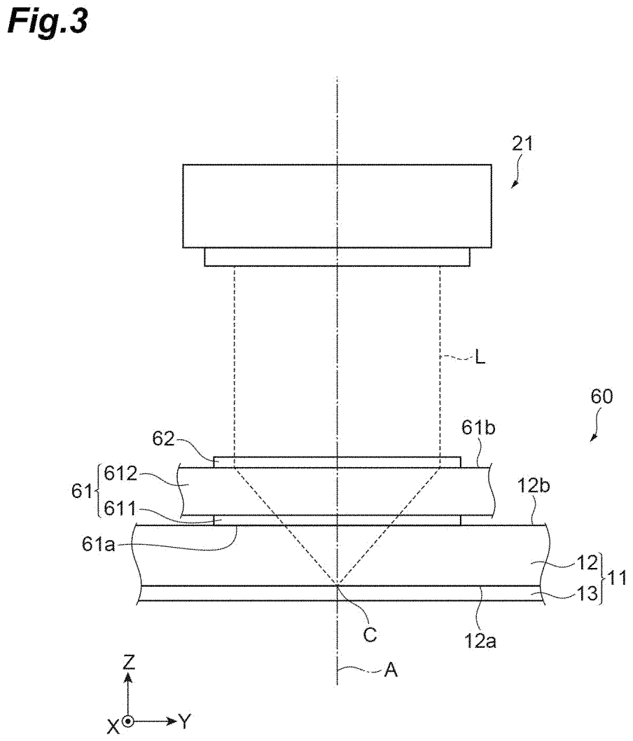

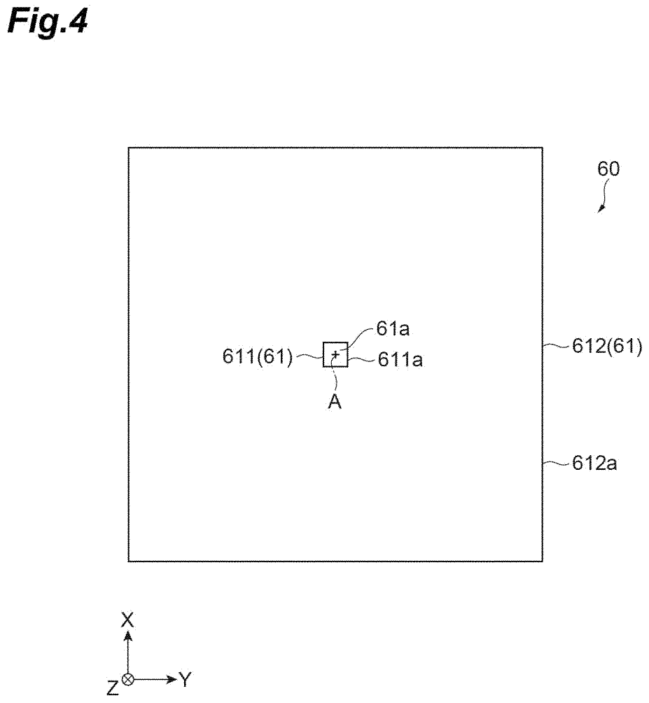

As illustrated in FIGS. 3, 4 and 5, the solid immersion lens 60 includes a base part 61 and a meta-lens 62. The base part 61 has the first surface 61a and a second surface 61b. The first surface 61a is a surface to be brought into contact with the semiconductor device 11 (specifically, the back surface 12b of the semiconductor substrate 12). The second surface 61b is a surface opposite to the first surface 61a. An area of the first surface 61a is smaller than an area of the second surface 61b. The area of the first surface 61a may be, for example, 0.001 times or more and 0.5 times or less than the area of the second surface 61b.

The base part 61 includes a first portion 611 having the first surface 61a and a second portion 612 having the second surface 61b. The first portion 611 and the second portion 612 are integrally formed. “Integrally formed” means that they are formed as a single member. An outer edge 612a of the second portion 612 is positioned outside an outer edge 611a of the first portion 611 when viewed from a direction (Z direction) parallel to the optical axis A of the solid immersion lens 60 (meta-lens 62). Further, in the optical apparatus 1, the optical axis A of the solid immersion lens 60 (meta-lens 62) coincides with the optical axis A of the objective lens 21.

Examples of shapes and dimensions of the first portion 611 and the second portion 612 are as follows. The first portion 611 has a rectangular plate shape (for example, a square plate shape) in which a length of one side is several millimeters or more and tens of millimeters or less and a thickness is tens of micrometers or more and hundreds of micrometers or less. The second portion 612 has a rectangular plate shape (for example, a square plate shape) in which a length of one side is tens of micrometers or more and hundreds of micrometers or less and a thickness is several micrometers or more and tens of micrometers or less. When viewed from a direction parallel to the optical axis A, a center of the first portion 611 coincides with a center of the second portion 612.

The base part 61 is formed of a material according to the refractive index of the semiconductor substrate 12 of the semiconductor device 11. As an example, when the semiconductor substrate 12 is a silicon substrate, the base part 61 is formed of silicon, gallium arsenide, gallium phosphide, or the like, and in this case, the refractive index of the base part 61 is about 3.5.

The meta-lens 62 is disposed on the second surface 61b of the base part 61. An example of a shape and dimensions of the meta-lens 62 (an aggregate of a plurality of antennas 70 to be described later) are as follows. The meta-lens 62 has a rectangular plate shape (for example, a square plate shape) in which a length of one side is tens of micrometers or more and hundreds of micrometers or less and a thickness is several micrometers or more and tens of micrometers or less. When viewed from the direction parallel to the optical axis A, a center of the meta-lens 62 coincides with the center of the second portion 612 of the base part 61.

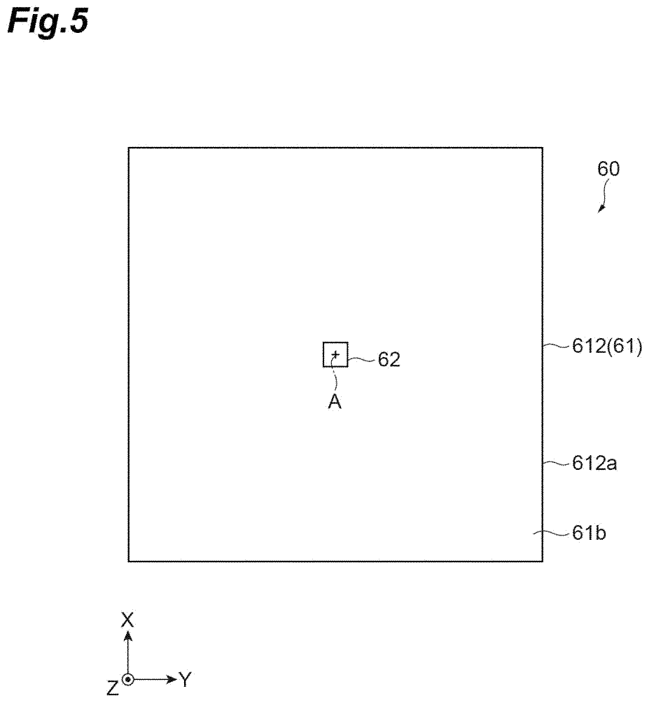

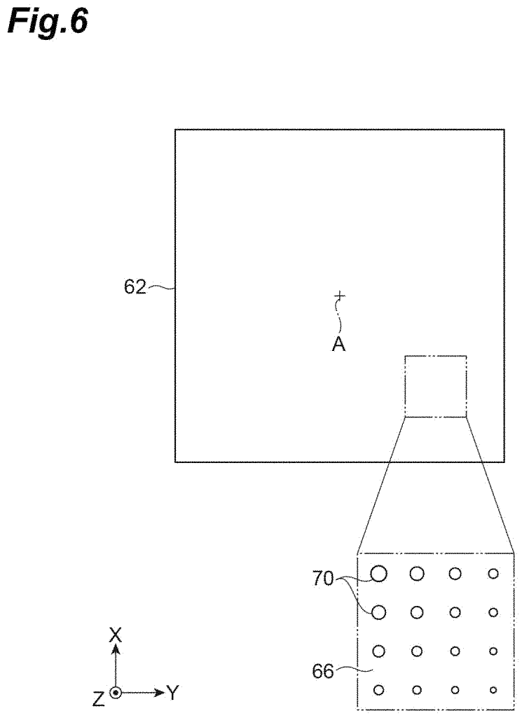

As illustrated in FIGS. 5 and 6, the meta-lens 62 includes the plurality of antennas 70. The “meta-lens” is an optical element that functions as a lens by having a meta-surface structure to be described later. Each of the antennas 70 is a member for adjusting an effective refractive index of the solid immersion lens 60. As an example, each antenna 70 has a pillar shape (more specifically, a columnar shape) in which an axis of each antenna 70 extends along the optical axis A. Further, a shape of each antenna 70 is not limited to a columnar shape or a pillar shape as long as the effective refractive index of the solid immersion lens 60 can be controlled.

Each antenna 70 may be formed integrally with the base part 61. For example, when the base part 61 is formed of silicon and each antenna 70 is formed integrally with the base part 61, a refractive index of each antenna 70 is about 3.5. That is, the refractive index of each antenna 70 is approximately the same as the refractive index of the semiconductor substrate 12 of the semiconductor device 11.

The antennas 70 are disposed two-dimensionally when viewed from the direction parallel to the optical axis A. As an example, the antennas 70 may be disposed periodically (more specifically, in a matrix shape) when viewed from the direction parallel to the optical axis A. A period in which the antennas 70 are disposed may be determined as follows. That is, incident light having a predetermined wavelength is made to be incident on the solid immersion lens 60. Here, infrared laser light output from, for example, the LSM unit 4 is made to be incident on the solid immersion lens 60. The antennas 70 may be disposed at a predetermined period smaller than a predetermined wavelength of the incident light incident on the solid immersion lens 60 when viewed from the direction parallel to the optical axis A. The “predetermined wavelength” may be, for example, a wavelength of 100 nm or more and 5200 nm or less, or a wavelength of 300 nm or more and 2000 nm or less. The “predetermined period” may be the same period in the entire region in which the plurality of antennas 70 are disposed, may be a different period for each portion of the region in which the plurality of antennas 70 are disposed, or may be a period that gradually changes along the region in which the plurality of antennas 70 are disposed. The “predetermined period” may be, for example, 20% or more and 100% or less of the predetermined wavelength, and specifically may be 100 nm or more and 5200 nm or less. In this case, light can be appropriately refracted by the plurality of antennas 70.

In the solid immersion lens 60, at least one of sizes, shapes, and dispositions of the plurality of antennas 70 change within the second surface 61b when viewed from the direction parallel to the optical axis A. Here, “changing within the second surface 61b” means that it may differ depending on a position on the second surface 61b. Thereby, the meta-lens 62 can adjust the effective refractive index of the solid immersion lens 60.

An intermediate portion 66 is a portion positioned between the plurality of antennas 70. “Positioned between the plurality of antennas 70” means, for example, that it is positioned to fill spaces between the plurality of antennas 70 without a gap. The intermediate portion 66 has a refractive index different from the refractive index of the antenna 70. A member whose material is different from that of the antenna 70 may be disposed as the intermediate portion 66, and the intermediate portion 66 may be an air layer.

In the solid immersion lens 60, the meta-lens 62 which is a portion in which the plurality of antennas 70 are disposed forms a so-called meta-surface structure. The “meta-lens 62” means a portion of the solid immersion lens 60 formed by the plurality of antennas 70 and the intermediate portion 66.

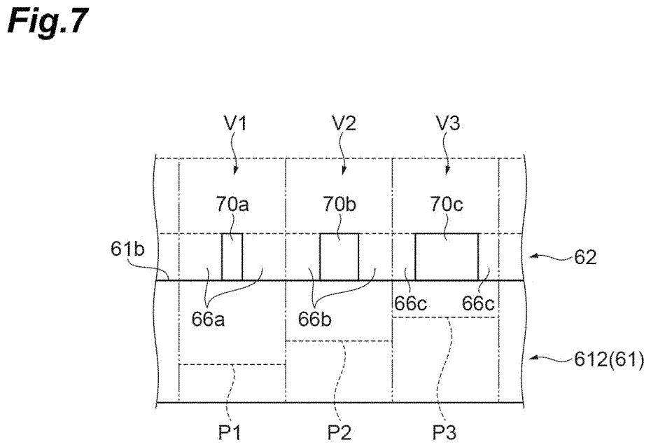

Here, the solid immersion lens 60 functioning as a lens will be described. FIG. 7 is a view for explaining that an effective refractive index has a distribution in the solid immersion lens 60. “Having a distribution” means that the effective refractive index may have a different state or a different value depending on a position. The solid immersion lens 60 has the following effective refractive index n_{eff} in the meta-lens 62. That is, when a filling factor a of the antenna 70 in a unit volume of the meta-lens 62, a refractive index nₘₛ of the antenna 70, and a refractive index n_{b} of the intermediate portion 66 are assumed, the effective refractive index n_{eff} is expressed by the following expression (1).

[Math. 1]

n_{eff}=\sqrt{anₘₛ²(1−a)n_{b}²} (1)

As described above, at least one of sizes, shapes, and dispositions of the antennas 70 changes within the second surface 61b when viewed from the direction parallel to the optical axis A. For example, FIG. 7 illustrates a configuration in which sizes of the antennas 70 change within the second surface 61b. In FIG. 7, an upper side of the meta-lens 62 is divided into portions V1, V2, and V3 of unit volumes. Then, positions P1, P2, and P3 having the same phase in transmitted light that has transmitted to a lower side of the meta-lens 62 when incident light having the same phase is incident on each of the portions V1, V2, and V3 from an upper side of the meta-lens 62 are each illustrated in FIG. 7.

In each of the portions V1, V2, and V3, sizes of the antenna 70 (cross-sectional areas when viewed from the direction parallel to the optical axis A) are different from each other. Here, an antenna 70a and an intermediate portion 66a are defined in the portion V1. In the portion V2, an antenna 70b and an intermediate portion 66b are defined. In the portion V3, an antenna 70c and an intermediate portion 66c are defined. The antenna 70a, the antenna 70b, and the antenna 70c become larger in that order. That is, in the portion V1, the portion V2, and the portion V3, the filling factor a of the antenna 70 increases in that order.

Thereby, the effective refractive index n_{eff} of each of the portions V1, V2, and V3 calculated by the above expression (1) increases in the order of the portion V1, the portion V2, and the portion V3, and the effective refractive index n_{eff} of the meta-lens 62 has a distribution. The position P1, the position P2, and the position P3 having the same phase in transmitted light that has transmitted to the lower side of the meta-lens 62 have distances from the first surface 61a that become smaller in that order. As a result of the phase difference occurring in the transmitted light as described above, the incident light is refracted by the meta-lens 62, and the solid immersion lens 60 functions as a lens by adjusting the effective refractive index n_{eff} of the meta-lens 62. For example, when the effective refractive index n_{eff} of the meta-lens 62 changes in a concentric shape around the optical axis A, the solid immersion lens 60 functions more suitably as a lens. Further, when the plurality of antennas 70 are disposed at a period smaller than a wavelength of the incident light, the incident light behaves as if the meta-lens 62 is a continuous medium having the effective refractive index n_{eff}.

The above-described “meta-surface structure” is a structure that functions as an optical element by having a plurality of disposed fine structures (for example, the antennas 70). For example, as the meta-surface structure, the following six types of typical methods (hereinafter, referred to as “first method to sixth method”) are exemplified.

The first method of the meta-surface structure is a so-called Multi-Resonance method, which is described in detail in “Nanfang Yu et al., “Light Propagation with Phase Discontinuities: Generalized Laws of Reflection and Refraction”, Science, 2011, 334, 333.” The first method has, for example, a plasmonic antenna and includes two types of resonance modes, a symmetric mode and an asymmetric mode, which are characterized by a current flowing through the plasmonic antenna.

The second method of the meta-surface structure is a so-called GAP-Plasmon method, which is described in detail in “S. Sun et al., “High-efficiency broadband anomalous reflection by gradient meta-surfaces”, Nano Letters, 2012,12, 6223.” The second method is, for example, a reflection type meta-surface structure having a MIM structure as a basic configuration, and a phase of light is modulated by a gap surface plasmon mode. The “gap surface plasmon mode” is a mode in which strong magnetic resonance occurs in a dielectric depending on induced currents of an upper antenna and a lower antenna facing in opposite directions. According to this, a reflection phase can be efficiently modulated by changing a length of the antenna.

The third method of the meta-surface structure is a so-called Pancharatnam-Berry phase (PB phase) method, which is described in detail in “Francesco Monticone et al., “Full Control of Nanoscale Optical Transmission with a Composite Metascreen”, Physical Review Letters, 2013, 110, 203903.” The third method modulates a phase by, for example, modulating angles of antennas having the same shape.

The fourth method of the meta-surface structure is a so-called Huygens-meta-surface method, which is described in detail in “tingling Huang et al., “Dispersionless Phase Discontinuities for Controlling Light Propagation”, Nano Letters, 2012, 12, 5750″ and “Manuel Decker et. al., “High-efficiency light-wave control with all-dielectric optical Huygens' meta-surfaces”, Advanced Optical Materials, 2015, 3, 813.” The fourth method reduces a reflectance by adjusting, for example, an electric dipole and a magnetic dipole at the same time at an interface of a medium having independent electromagnetic field characteristics.

The fifth method of the meta-surface structure is a so-called High-Contrast method, which is described in detail in “Seyedeh M. Kamali et al., “Decoupling optical function and geometrical form using conformal flexible dielectric meta-surfaces”, Nature Communications, 2016, 7, 11618.” The fifth method realizes a plurality of modes of Fabry-Perot resonance with a low Q value by utilizing, for example, a large difference in refractive index between an antenna and the surrounding medium. An electric dipole and a magnetic dipole are included in the plurality of modes.

The sixth method of the meta-surface structure is a so-called Gradient-Index method, which is described in detail in “Philippe Lalanne et al., “Design and fabrication of blazed binary diffractive elements with sampling periods smaller than the structural cutoff”, Journal of the Optical Society of America. A, 1999, 16 (5), 1143.” The sixth method modulates phases (effective refractive indexes) of media having different refractive indexes using a change in filling factor in a unit cell thereof.

The solid immersion lens 60 configured as described above focuses the infrared laser light L emitted from the light source 4a on a predetermined portion of the semiconductor device 11. An operation of the solid immersion lens 60 will be described with reference to FIG. 3.

As illustrated in FIG. 3, the infrared laser light L emitted from the light source 4a of the LSM unit 4 is refracted by the meta-lens 62 of the solid immersion lens 60, passes through the second portion 612 of the base part 61 of the solid immersion lens 60, the first portion 611 of the base part 61 of the solid immersion lens 60, and the semiconductor substrate 12 of the semiconductor device 11 in that order, and is focused on the integrated circuit 13. That is, a focusing point C of the infrared laser light L is positioned on the integrated circuit 13.

The focusing point C of the infrared laser light L is made on the semiconductor device 11 side (opposite to the meta-lens 62 with respect to the first portion 611 of the solid immersion lens 60). Therefore, when a thickness of the base part 61 of the solid immersion lens 60 is adjusted, a distance between the meta-lens 62 and the focusing point C can be controlled. Since the distance between the meta-lens 62 and the focusing point C can be controlled, a size of the meta-lens 62 effective as a lens is not limited, a degree of freedom in phase design improves, and thus it is effective in aberration correction or the like.

Since the infrared laser light L passes through the first portion 611 of the base part 61 of the solid immersion lens 60, a size of the first portion 611 is a size through which the infrared laser light L can pass. That is, the size of the first portion 611 may be equal to or larger than a size through which the infrared laser light L can pass, and the first portion 611 can be miniaturized according to an optical path of the infrared laser light L.

The infrared laser light L focused on the focusing point C is reflected by the integrated circuit 13 of the semiconductor device 11. The reflected light from the semiconductor device 11 passes through the semiconductor substrate 12 of the semiconductor device 11, the first portion 611 of the base part 61 of the solid immersion lens 60, and the second portion 612 of the base part 61 of the solid immersion lens 60 in that order, is detected by the photodetector 4b, and thereby the semiconductor device 11 can be observed.

### [Method of Manufacturing Solid Immersion Lens]

### [Method of Forming Meta-Lens]

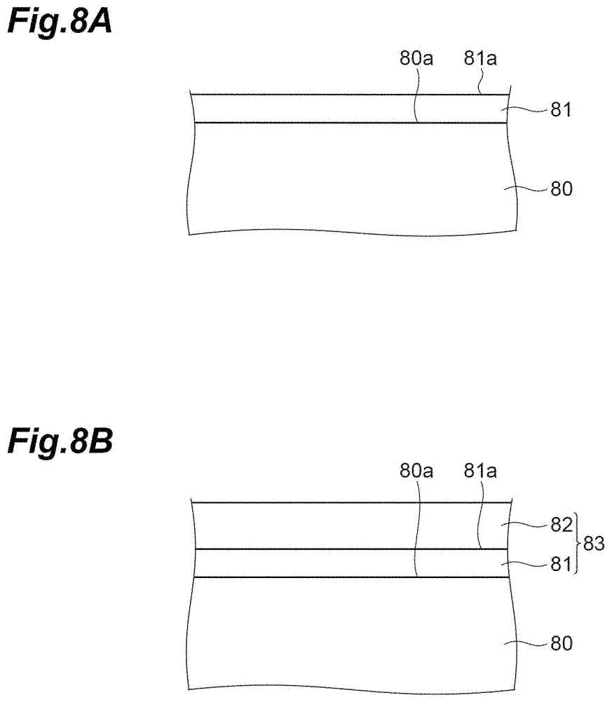

A method of manufacturing the solid immersion lens 60 will be described. First, a method of forming the meta-lens 62 of the solid immersion lens 60 will be described with reference to FIGS. 8A to 10B. FIGS. 8A to 10B are views for explaining a method of forming the meta-lens 62 of the solid immersion lens 60.

First, as illustrated in FIGS. 8A and 8B, a mask layer 83 is formed on a substrate 80 serving as the base part 61 of the solid immersion lens 60 (layer forming step). The mask layer 83 is formed by laminating a hard mask 81 and a resist 82. A shape of the substrate 80 may be a thin film shape or a flat plate shape.

As illustrated in FIG. 8A, the hard mask 81 is formed on an upper surface 80a of the substrate 80. The hard mask 81 can be formed by, for example, resistance heating vapor deposition. As a material of the hard mask 81, silicon nitride or the like can be exemplified. A thickness of the hard mask 81 can be, for example, about 300 nm.

Next, as illustrated in FIG. 8B, the resist 82 is formed on an upper surface 81a of the hard mask 81. The resist 82 can be formed by, for example, applying an electron beam resist. As a material of the resist 82, an electron beam resist such as ZEP520A can be exemplified. A thickness of the resist 82 can be, for example, about 300 nm.

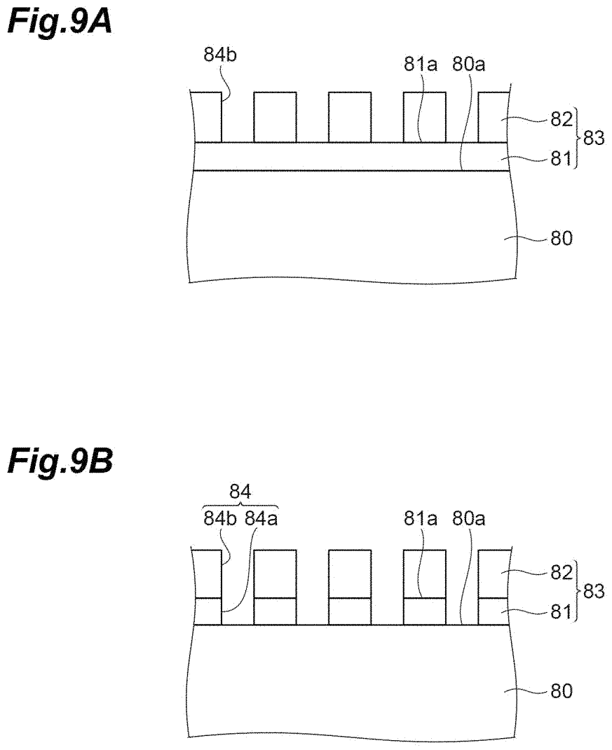

Next, as illustrated in FIGS. 9A and 9B, a plurality of openings 84 are formed in the mask layer 83 formed on the substrate 80 (opening step). The openings 84 each include a hard mask opening 84a formed in the hard mask 81 and a resist opening 84b formed in the resist 82. The hard mask opening 84a is formed via the resist opening 84b. Therefore, the hard mask opening 84a and the resist opening 84b are formed at the same position as each other when viewed from the direction perpendicular to the upper surface 80a of the substrate 80. The resist opening 84b can be formed by performing electron beam lithography and development on the resist 82. The hard mask opening 84a can be formed by performing induced coupled plasma-reactive ion etching (ICP-RIE) on the hard mask 81.

The mask layer 83 after the opening step may be formed to be periodically disposed when viewed from a direction perpendicular to the upper surface 80a of the substrate 80. More specifically, when incident light having a predetermined wavelength is incident on the solid immersion lens 60, the mask layer 83 may be formed to be disposed at a period smaller than the predetermined wavelength when viewed from the direction perpendicular to the upper surface 80a of the substrate 80. Here, a size, a shape, and a disposition of the mask layer 83 are the size, the shape, and the disposition of the antenna 70 of the meta-lens 62. The mask layer 83 may have, for example, a circular shape having a diameter of 50 nm or more and 270 nm or less. Also, the mask layer 83 may be formed to be disposed, for example, in a period of 300 nm. Further, at least one of sizes, shapes, and dispositions of a plurality of mask layers 83 may change within the upper surface 80a of the substrate 80 when viewed from the direction perpendicular to the upper surface 80a of the substrate 80. Here, “changing within the upper surface 82a of the substrate 80” means that it may differ depending on a position on the upper surface 82a of the substrate 80.

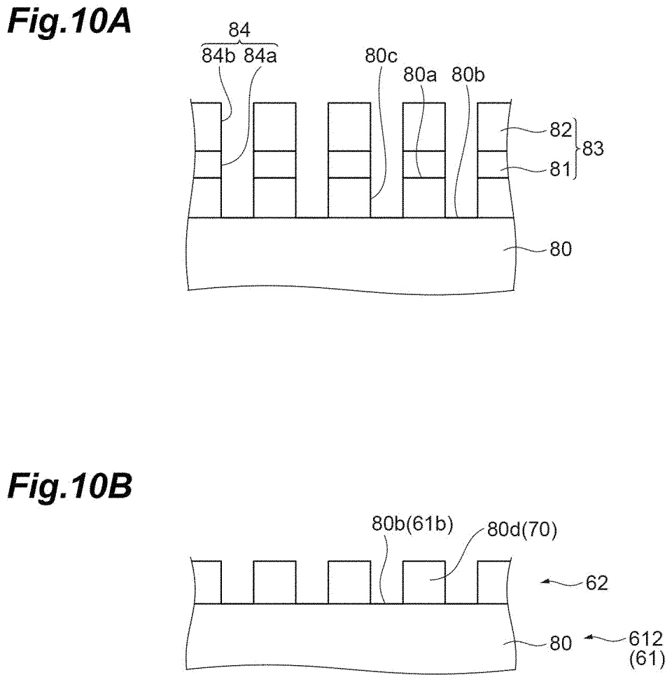

Next, as illustrated in FIG. 10A, etching is performed through the plurality of openings 84 to form a plurality of recessed parts 80c in the substrate 80 (etching step). As the etching, for example, dry etching may be performed, and particularly, reactive ion etching (RIE) may be performed. The etching is performed from the upper surface 80a of the substrate 80 to an upper surface 80b inside the substrate 80. Thereby, the recessed part 80c having a predetermined depth (etching depth) can be formed on the upper surface 80a of the substrate 80. The etching depth can be, for example, about 800 nm.

Next, as illustrated in FIG. 10B, the mask layer 83 is removed (removal step). That is, the hard mask 81 is lifted off. Thereby, the resist 82 formed on the hard mask 81 can be removed together with the hard mask 81. As a result, the upper surface 80a and the upper surface 80b can be formed on the substrate 80. Then, a protruding part 80d having the upper surface 80a serves as the antenna 70 of the meta-lens 62 of the solid immersion lens 60, and the upper surface 80b serves as the second surface 61b of the solid immersion lens 60. Thereby, the meta-lens 62 of the solid immersion lens 60 can be formed.

### [Method of Forming First Portion]

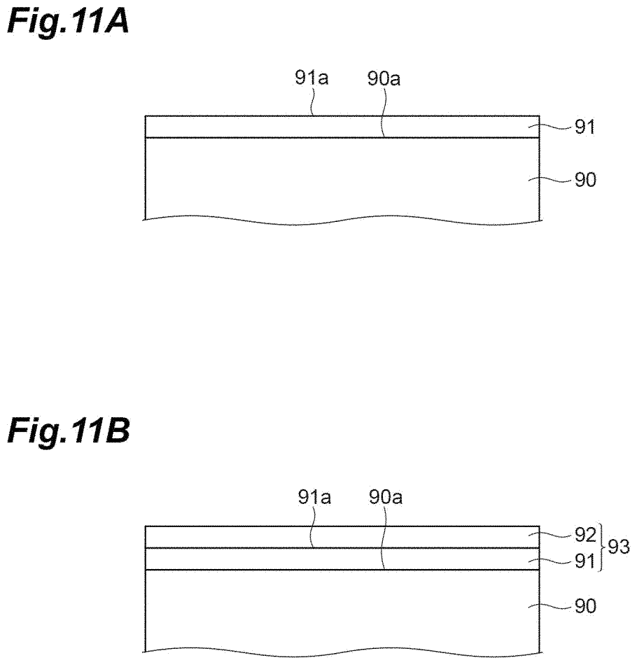

Next, a method of forming the first portion 611 of the solid immersion lens 60 will be described with reference to FIGS. 11A to 13B. FIGS. 11A to 13B are views for explaining a method of forming the first portion 611 of the solid immersion lens 60.

First, as illustrated in FIGS. 11A and 11B, a mask layer 93 is formed on a substrate 90 which will become the base part 61 of the solid immersion lens 60 (layer forming step). The mask layer 93 is formed by laminating a hard mask 91 and a resist 92. A shape of the substrate 90 may be a thin film shape or a flat plate shape.

As illustrated in FIG. 11A, the hard mask 91 is formed on an upper surface 90a of the substrate 90. The hard mask 91 can be formed by, for example, resistance heating vapor deposition. As a material of the hard mask 91, silicon nitride or the like can be exemplified. A thickness of the hard mask 91 can be, for example, about 300 nm.

Next, as illustrated in FIG. 11B, the resist 92 is formed on an upper surface 91a of the hard mask 91. The resist 92 can be formed by, for example, applying an electron beam resist. As a material of the resist 92, an electron beam resist such as ZEP520A can be exemplified. A thickness of the resist 92 can be, for example, about 300 nm.

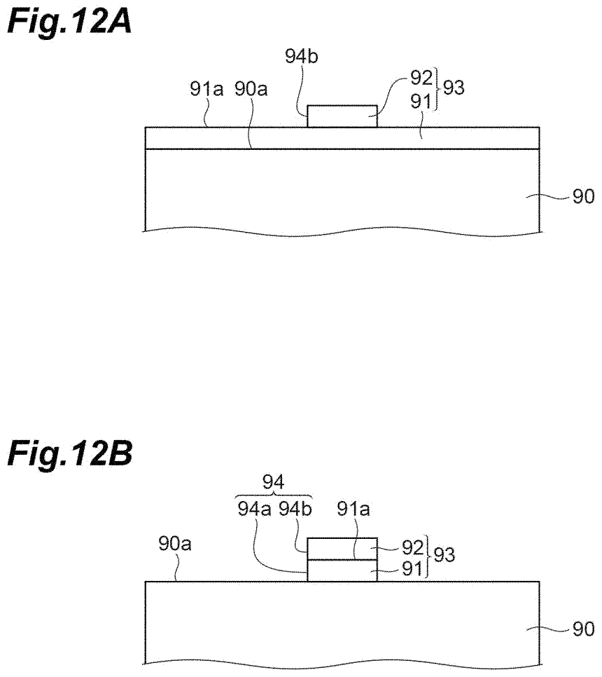

Next, as illustrated in FIGS. 12A and 12B, the mask layer 93 formed on the substrate 90 is removed (removal step). The portion (removed part 94) removed from the mask layer 93 formed on the substrate 90 includes a hard mask removed part 94a removed from the hard mask 91 and a resist removed part 94b removed from the resist 92. The hard mask removed part 94a is removed via the resist removed part 94b. Therefore, the hard mask removed part 94a and the resist removed part 94b are at the same position as each other when viewed from a direction perpendicular to the upper surface 90a of the substrate 90. The resist removed part 94b can be removed by performing electron beam lithography and development on the resist 92. The hard mask removed part 94a can be removed by performing induced coupled plasma-reactive ion etching (ICP-RIE) on the hard mask 91.

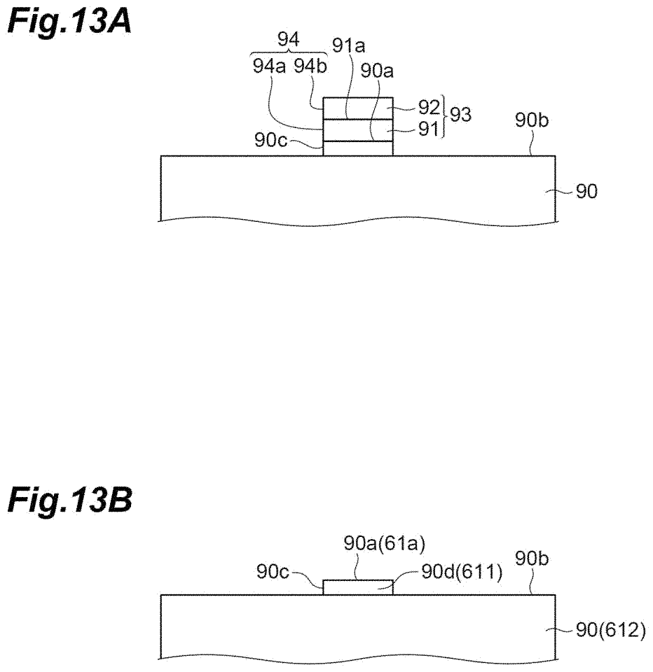

Next, as illustrated in FIG. 13A, etching is performed through the removed part 94 to remove the substrate 90 to a predetermined depth (etching depth) (etching step). As the etching, for example, dry etching may be performed, and particularly, reactive ion etching (RIE) may be performed. The etching is performed from the upper surface 90a of the substrate 90 to the upper surface 90b inside the substrate 90. The etching depth can be, for example, about 5 μm.

Next, as illustrated in FIG. 13B, the mask layer 93 is removed (mask layer removing step). That is, the hard mask 91 is lifted off. Thereby, the resist 92 formed on the hard mask 91 can be removed together with the hard mask 91. As a result, the upper surface 90a and the upper surface 90b can be formed on the substrate 90. Then, a protruding part 90d having the upper surface 90a serves as the first portion 611 of the base part 61 of the solid immersion lens 60. As described above, the first portion 611 of the solid immersion lens 60 can be formed.

### [Operation and Effects]

As described above, in the optical apparatus 1, the solid immersion lens 60 includes the meta-lens 62 disposed on the second surface 61b of the base part 61. Thereby, the effective refractive index of the meta-lens 62 can be controlled by controlling at least one of sizes, shapes, and dispositions of the plurality of antennas 70 included in the meta-lens 62 in a direction along the second surface 61b of the base part 61. Therefore, the solid immersion lens 60 can be made thinner. Also, when the solid immersion lens 60 is brought into contact with the semiconductor device 11, the first surface 61a of the base part 61 is brought into contact with the semiconductor device 11. Thereby, the solid immersion lens 60 can be easily handled as compared with, for example, a case in which the meta-lens 62 is brought into contact with the semiconductor device 11. Therefore, according to the optical apparatus 1, thinning of the solid immersion lens 60 and easy handling of the solid immersion lens 60 can be realized.

Also, according to the optical apparatus 1, since the optical device serves as the photodetector 4b, light emitted from the semiconductor device 11 or light reflected by the semiconductor device 11 can be detected with high accuracy.

Also, according to the optical apparatus 1, since the optical device serves as the light source 4a, the semiconductor device 11 can be irradiated with light with high accuracy.

Also, according to the optical apparatus 1, since the area of the first surface 61a of the solid immersion lens 60 is smaller than the area of the second surface 61b, the first surface 61a of the base part 61 can be reliably brought into contact with the semiconductor device 11, for example, to prevent intervention of an air layer while a sufficient size for holding the solid immersion lens 60 is secured on the base part 61.

Also, according to the optical apparatus 1, since the objective lens 21 is provided at a position between the solid immersion lens 60 and the optical device (the light source 4a, the photodetector 4b) on the optical path, a focus of the objective lens 21 can be accurately aligned with a desired position of the semiconductor device 11.

Also, according to the solid immersion lens 60, as described above, thinning of the solid immersion lens 60 and easy handling of the solid immersion lens 60 can be realized. Further, the first surface 61a of the base part 61 can be reliably brought into contact with the semiconductor device 11, for example, to prevent intervention of an air layer while a sufficient size for holding the solid immersion lens 60 is secured on the base part 61.

Also, according to the solid immersion lens 60, the base part 61 may include the first portion 611 having the first surface 61a and the second portion 612 having the second surface 61b, the outer edge 612a of the second portion 612 may be positioned outside the outer edge 611a of the first portion 611 when viewed from a direction parallel to the optical axis A of the meta-lens 62, and the first portion 611 and the second portion 612 may be integrally formed. According to this, the solid immersion lens 60 can be stably held on the second portion 612. Also, an interface causing refraction and reflection of light can be prevented from being formed between the first portion 611 and the second portion 612.

### Modified Example

The embodiment described above can be implemented in various forms in which various changes and improvements are made on the basis of knowledge of those skilled in the art.

Also, in the embodiment described above, the light source of the optical apparatus 1 is not limited to the light source 4a configured to irradiate the infrared laser light L. The light source of the optical apparatus 1 may be a light source configured to irradiate ultraviolet light or a light source configured to irradiate visible light.

Also, in the embodiment described above, the optical apparatus 1 includes the light source 4a and the photodetector 4b, but the optical apparatus 1 may be configured as an illuminating device having a light source and not having a photodetector or may be configured as an observation device not having a light source and having a photodetector.

Also, in the embodiment described above, the optical apparatus 1 may not include the objective lens 21. When the optical apparatus 1 does not include the objective lens 21, the apparatus can be miniaturized.

Also, in the embodiment described above, the solid immersion lens holder 8 is not limited to the configuration of the above-described embodiment as long as it can hold the solid immersion lens 60. For example, the lens holding part 8b of the solid immersion lens holder 8 may not have a gap with respect to the solid immersion lens 60.

Also, in the embodiment described above, the semiconductor device 11 may not be molded with the resin 14 as the mold-type semiconductor device 10.

For example, in the embodiment described above, the solid immersion lens 60 is not particularly limited in shape when viewed from the direction parallel to the optical axis A and may have, for example, a circular shape when viewed from the direction parallel to the optical axis A.

Also, in the embodiment described above, the first portion 611 of the base part 61 of the solid immersion lens 60 is not particularly limited in shape when viewed from the direction parallel to the optical axis A and may have, for example, a circular shape when viewed from the direction parallel to the optical axis A.

Also, in the embodiment described above, the first portion 611 and the second portion 612 of the base part 61 of the solid immersion lens 60 may not be integrally formed. The first portion 611 and the second portion 612 of the base part 61 of the solid immersion lens 60 may be formed of different materials.

Also, in the embodiment described above, the antenna 70 is not particularly limited in shape. For example, the antenna 70 may have a shape corresponding to a method of a meta-surface structure of the meta-lens 62.

Also, in the embodiment described above, the antenna 70 may not be formed of silicon. For example, the antenna 70 may be formed of germanium, gold, silver, chromium, or the like. Even in these cases, the effective refractive index of the meta-lens 62 can be set to a suitable value.

Also, in the embodiment described above, the antenna 70 is not limited to the disposition in the embodiment described above as long as the infrared laser light L emitted from the light source 4a of the LSM unit 4 can be focused on a predetermined portion of the semiconductor device 11. For example, the antennas 70 may be periodically disposed to be a honeycomb shape, a radial shape, or the like when viewed from the direction parallel to the optical axis A, or may be disposed aperiodically when viewed from the direction parallel to the optical axis A.

An optical apparatus of one aspect of the present disclosure includes a support part configured to support an object, a solid immersion lens configured to be brought into contact with the object supported by the support part, and an optical device disposed at a position opposite to the support part with respect to the solid immersion lens on an optical path passing through the solid immersion lens, in which the solid immersion lens includes a base part having a first surface to be brought into contact with the object and a second surface opposite to the first surface, and a meta-lens disposed on the second surface.

In the optical apparatus, the solid immersion lens includes the meta-lens disposed on the second surface of the base part. Thereby, an effective refractive index of the meta-lens can be controlled by controlling at least one of sizes, shapes, and dispositions of the plurality of antennas included in the meta-lens in a direction along the second surface of the base part. Therefore, the solid immersion lens can be made thinner. Also, when the solid immersion lens is brought into contact with the object, the first surface of the base part is brought into contact with the object. Thereby, the solid immersion lens can be easily handled as compared with, for example, a case in which the meta-lens is brought into contact with the object. Therefore, according to the optical apparatus, thinning of the solid immersion lens and easy handling of the solid immersion lens can be realized.

In the optical apparatus of one aspect of the present disclosure, the optical device may be a photodetector. According to this, light emitted from the object or light reflected by the object can be detected with high accuracy.

In the optical apparatus of one aspect of the present disclosure, the optical device may be a light source. According to this, the object can be irradiated with light with high accuracy.

In the optical apparatus of one aspect of the present disclosure, an area of the first surface may be smaller than an area of the second surface. According to this, the first surface of the base part can be reliably brought into contact with the object, for example, to prevent intervention of an air layer while a sufficient size for holding the solid immersion lens is secured on the base part.

In the optical apparatus of one aspect of the present disclosure, the base part includes a first portion having the first surface and a second portion having the second surface, an outer edge of the second portion is positioned outside an outer edge of the first portion when viewed from a direction parallel to an optical axis of the meta-lens, and the first portion and the second portion are integrally formed. According to this, the solid immersion lens can be stably held on the second portion. Also, an interface causing refraction and reflection of light can be prevented from being formed between the first portion and the second portion.

The optical apparatus of one aspect of the present disclosure may further include an objective lens disposed at a position between the solid immersion lens and the optical device on the optical path. According to this, a focus of the objective lens can be accurately aligned with a desired position of the object.

In the optical apparatus of one aspect of the present disclosure, the object may be a semiconductor device. According to this, for example, a failure analysis of a semiconductor device can be performed with high accuracy.

A solid immersion lens of one aspect of the present disclosure includes a base part having a first surface to be brought into contact with an object and a second surface opposite to the first surface, and a meta-lens disposed on the second surface, in which an area of the first surface is smaller than an area of the second surface.

According to the solid immersion lens, as described above, thinning of the solid immersion lens and easy handling of the solid immersion lens can be realized. Also, the first surface of the base part can be reliably brought into contact with the object, for example, to prevent intervention of an air layer while a sufficient size for holding the solid immersion lens is secured on the base part.

In the solid immersion lens of one aspect of the present disclosure, the base part includes a first portion having the first surface and a second portion having the second surface, an outer edge of the second portion is positioned outside an outer edge of the first portion when viewed from a direction parallel to an optical axis of the meta-lens, and the first portion and the second portion are integrally formed. According to this, the solid immersion lens can be stably held on the second portion. Also, an interface causing refraction and reflection of light can be prevented from being formed between the first portion and the second portion.

According to the present disclosure, it is possible to provide an optical apparatus including a solid immersion lens in which thinning and easy handling are realized, and such a solid immersion lens.

What is claimed is:

1. An optical apparatus comprising:
a support part configured to support an object;
a solid immersion lens configured to be brought into contact with the object supported by the support part; and
an optical device disposed at a position opposite to the support part with respect to the solid immersion lens on an optical path passing through the solid immersion lens, wherein
the solid immersion lens includes:
a base part having a first surface to be brought into contact with the object and a second surface opposite to the first surface; and
a meta-lens disposed on the second surface.

2. The optical apparatus according to claim 1, wherein the optical device is a photodetector.

3. The optical apparatus according to claim 1, wherein the optical device is a light source.

4. The optical apparatus according to claim 1, wherein an area of the first surface is smaller than an area of the second surface.

5. The optical apparatus according to claim 1, wherein
the base part includes a first portion having the first surface and a second portion having the second surface,
an outer edge of the second portion is positioned outside an outer edge of the first portion when viewed from a direction parallel to an optical axis of the meta-lens, and
the first portion and the second portion are integrally formed.

6. The optical apparatus according to claim 1, further comprising an objective lens disposed at a position between the solid immersion lens and the optical device on the optical path.

7. The optical apparatus according to claim 1, wherein the object is a semiconductor device.

8. A solid immersion lens comprising:
a base part including a first surface to be brought into contact with an object and a second surface opposite to the first surface; and
a meta-lens disposed on the second surface, wherein
an area of the first surface is smaller than an area of the second surface.

9. The solid immersion lens according to claim 8, wherein
the base part includes a first portion having the first surface and a second portion having the second surface,
an outer edge of the second portion is positioned outside an outer edge of the first portion when viewed from a direction parallel to an optical axis of the meta-lens, and
the first portion and the second portion are integrally formed.
